(19) United States
(12) Patent Application Publication
(10) Pub. No.: US 2020/0275613 A1
(43) Pub. Date: Sep. 3, 2020

(54) Vegetated Canopy Apparatus, System, and Method

(71) Applicant: University of Maryland, College Park, Frederick, MD (US)

(72) Inventors: David R. TILLEY, University Park, MD (US); Nick CLOYD, Berwyn Heights, MD (US)

(73) Assignee: University of Maryland, College Park, Frederick, MD (US)

(21) Appl. No.: 16/878,593

(22) Filed: May 19, 2020

Related U.S. Application Data
(63) Continuation-in-part of application No. 15/770,852, filed on Apr. 25, 2018.
(60) Provisional application No. 62/248,480, filed on Oct. 30, 2015.

(51) Int. Cl. A01G 9/12; A01G 27/00; A01C 23/04

(52) U.S. Cl. CPC A01G 9/12; A01G 27/003; A01C 23/042; A01G 27/008; A01G 27/001

(57) ABSTRACT

A vegetated canopy is provided with a support structure and a vegetation support assembly including a plurality of soil containers supported by a plurality of brackets, a plurality of ribs supported by a plurality of supporting members, and a plurality of connecting members forming a trellis structurally configured to support the vegetation of vascular plants growing in the soil containers. The vegetated canopy includes plant- and vine-friendly support structures and may include irrigation and drainage systems, including a ‘smart’ irrigation system powered by solar energy, to support plant and foliage growth and health. The vegetated system provides a shade canopy that may block the sun's rays, lower the surrounding temperature through plant transpiration and ecosystem evaporation, and facilitate ease of use, transportation, and maintenance through automation and modularity.

### CROSS-REFERENCE TO RELATED APPLICATIONS

This application is a continuation-in-part to U.S. Non-provisional patent application Ser. No. 15/770,852, filed on Apr. 25, 2018, a national stage entry application of International Patent Application No. PCT/IB2016/05644, filed on Oct. 26, 2016, which claims priority to U.S. Provisional Patent Application No. 62/248,480, filed on Oct. 30, 2015.

These prior applications are incorporated herein by reference in their entireties.

### BACKGROUND OF THE INVENTION

### Field of the Invention

The present invention is directed generally to a vegetated canopy, and more particularly to improvements to a vegetated canopy utilizing automation and modularity to improve both ease of use and function in providing a support for growth of vegetation. Technology in the Field of the Invention

Vegetated canopies of the prior art often consist of hanging plants disposed on an elevated structure. Vegetated canopies of the prior art may also include climbing plants originating from soil containers disposed at or near a base of a structure for ease of access, e.g., for watering and maintenance. More complex vegetated canopies may include a trellis, e.g., a framework of light wooden or metal bars used to support climbing plants, attached to an elevated structure in a permanent manner. These vegetated canopies are often cumbersome to assemble, transport, and maintain. For example, it is often cumbersome or impossible for a user to move the vegetated canopy, or to exchange or replace a plant of the vegetated canopy, e.g., due to a change in season, when a plant fails, or otherwise. Furthermore, watering these vegetated canopies often requires climbing a ladder or otherwise accessing the elevated vegetation, which may be undesirable, impractical, or impossible for some users of the system. The vegetated canopies of the prior art generally do not provide a drainage system, which prevents use of the canopy during or immediately following heavy rainfall or watering of plants due to excess fluid spillage. Additionally, these vegetated canopies often lack vine-friendly support structures, which hinders plant and foliage growth required for a true shade canopy. Thus, there remains a need for improved apparatuses, systems, and methods for providing vegetated canopies.

The inventors' prior disclosure, while presenting some fundamental innovations, did not suggest certain useful engineering features described by the present invention. It is the objective of the present disclosure to enable through descriptive teaching the method of manufacture and system design of a novel vegetated canopy with superior performance to previous vegetated canopies.

### BRIEF SUMMARY OF THE INVENTION

In an exemplary embodiment of the vegetated canopy apparatus and system of the present invention, the vegetated canopy includes a support structure that attaches to and supports a vegetation support assembly. The vegetation support assembly may be an umbrella-like structure configured to support hanging soil containers from brackets and support vegetation atop a trellis formed by ribs, supports, and connecters between the ribs. The support structure includes a base for stability and one or more posts that elevate and support the vegetation support assembly. The trellis may be further configured to open and close for ease of assembly, disassembly, and transportation by hinged connections between the trellis ribs and supports, hinged connections between the trellis ribs and the top of the support structure, and hinged and slidably moveable connections between supports and a post of the support structure. The user of the system may open and close the trellis with ease and may secure the trellis in the open position to support placement and growth of vegetation.

In another exemplary embodiment of the vegetated canopy apparatus and system of the present invention, the vegetated canopy includes an irrigation system with an irrigation supply line configured to bring water and nutrients from the bottom of the apparatus to the soil containers near the top where drip emitters deliver the water and nutrients to the soil containers. The irrigation system may include a water reservoir or connection to an external water reservoir and may include a programmable controller operable to irrigate the plants to promote plant growth and health. The irrigation system may also include ‘smart’ irrigation components, including a controller, a pump, a valve, one or more moisture sensors, one or more photovoltaic panels, a rechargeable battery, and electrical wiring that couples components together in order to maintain the health of vegetation included on the vegetated canopy with minimal or no external maintenance required.

In another exemplary embodiment of the vegetated canopy apparatus and system of the present invention, the vegetated canopy includes a drainage system with a drain line configured to remove excess fluid from the soil containers to prevent root rot and undesirable overflow from the soil containers. Individual drain lines from individual soil containers may join a main drain line that drains the excess fluid into the posts of the support structure where the main drain line terminates. In another form of the present invention, the main drain line may extend to the bottom of the apparatus where it terminates and drains excess fluid. In another form of the present invention, the main drain line terminates in the water reservoir to replenish the supply of water. In yet another form of the present invention, the main drain line may extend beyond the bottom of the apparatus where it terminates and drains excess fluid away from the apparatus.

In these and other alternative embodiments of the vegetated canopy system and method of the present invention, a user procures and assembles the components of the apparatus and system, which may include support structure, vegetation support assembly, irrigation system, including a ‘smart’ irrigation system, and drainage system. The user may plant vascular plants, for example flowering vines such as those of the genus Mandevilla, in the soil containers, hang the soil containers from the brackets, install individual irrigation lines to each soil container, install individual drain lines from each soil container to a main drain line, install moisture sensors in each soil container, and arrange the vegetation atop the trellis to optimize aesthetic appearance and shade provision. The user may easily replace individual plants with different plants by removing irrigation lines, drain lines, and moisture sensors, switching the soil containers, and re-installing the irrigation lines, drain lines, and moisture sensors.

It is an object of the present invention to provide a novel vegetated canopy with advanced engineering to provide plant- and vine-friendly support structures as well as ‘smart’ irrigation and drainage systems to promote plant and foliage growth required for a true shade canopy.

It is another object of the present invention to provide a vegetated canopy, apparatus, and method for use in residential and commercial settings, including the harshest environments in urban, seaside, or arid settings of diverse moisture classifications, to both block the sun's rays and promote plant transpiration and ecosystem evaporation to lower the surrounding temperature.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. The drawings are not necessarily to scale, emphasis instead being placed upon illustrating the principles of the devices, systems, and methods described herein. In these drawings, like reference numerals identify corresponding elements.

FIG. 1 is a perspective view of a system for supporting vegetation with a vegetation support assembly, support structure, and irrigation and drainage systems according to an embodiment of the present invention.

FIG. 2A is a perspective view of the support structure and some components of the irrigation system of the embodiment depicted in FIG. 1.

FIG. 2B is a perspective view of the support structure and some components of the irrigation and drainage systems according to an embodiment of the present invention.

FIG. 2C is a perspective view of the support structure and some components of the irrigation system of an embodiment of the present invention.

FIG. 2D is a perspective view of the support structure and some components of the irrigation system of an embodiment of the present invention.

FIG. 3A is a perspective view of a soil container with a cut away view depicting some components of the irrigation and drainage systems according to an embodiment of the present invention.

FIG. 3B is a perspective view of a plurality of soil containers depicted in FIG. 3A disposed at the top end of a support structure according to an embodiment of the present invention.

FIG. 4 is a perspective view of a plurality of soil containers disposed at the top end of the support structure and components are configured to form a trellis to support vegetation according to an embodiment of the present invention.

FIG. 5 is a perspective view of the embodiment depicted in FIG. 4 upon reconfiguration of the trellis to a collapsed configuration.

FIG. 6A is a perspective view of a system with a vegetation support assembly, support structure, and irrigation and drainage systems for supporting vegetation growing from one soil container according to an embodiment of the present invention.

FIG. 6B is a perspective view of a system with a vegetation support assembly, support structure, and irrigation and drainage systems for supporting vegetation growing from a plurality of soil containers according to an embodiment of the present invention.

FIG. 7 illustrates a flow chart of a method for providing a vegetated canopy, in accordance with a representative embodiment.

### DETAILED DESCRIPTION OF CERTAIN EMBODIMENTS

The various apparatuses, systems, methods, and devices described herein generally provide for vegetated canopies and the like.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description below, like reference numerals may be used to describe the same, similar or corresponding parts in the several views of the drawings.

In the following description, it is understood that relational terms such as “first,” “second,” “top,” “bottom,” and the like, are words of convenience and are not to be construed as limiting terms. These words may be used solely to distinguish one entity or action from another entity or action without necessarily requiring or implying any actual such relationship or order between such entities or actions. Also, the terms apparatus and device may be used interchangeably in this text.

The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” or similar terms means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

All documents mentioned herein are hereby incorporated by reference in their entirety. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The word “about” or the like, when accompanying a numerical value, is to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

As discussed herein, the disclosure may include methods, systems, apparatuses, and devices for providing vegetated canopies and the like. In general, a “trellis” as described herein may include an open framework of intersecting parts to support and display vegetation. In general, a “canopy” as described herein may include any covering, including full covering or partial covering. A “vegetated canopy” as described herein is a system for supporting vegetation that may include use of one or more of vines, herbs, woody shrubs, woody trees, climbing plants, clinging plants, or other plant materials as a canopy.

A vegetated canopy may advantageously provide one or more of a naturally shaded environment, a naturally cooled environment, an environment with reduced volatile organic toxins, an environment with reduced noise levels, an environment with reduced ultraviolet radiation, and the like. In other words, a vegetated canopy may advantageously reduce the penetration through the canopy of ultraviolet, visible, and near-infrared light emanating from the sun, to provide a naturally-designed aesthetic, reduce the use of artificial textile materials, offer a living, regenerative canopy, and allow for a cooler ambient temperature due to the evaporative cooling of vascular plant transpiration (i.e., water emitted from the leaf, which has an evaporative cooling effect).

Implementations may generally include a vegetation support assembly and a support structure configured to attach to and support the vegetation support assembly. The vegetation support assembly and the support structure may combine to form a vegetated canopy system. Such a vegetated canopy system may be self-contained to allow for mobility of the system, and substantially self-sustaining, allowing for ease of maintenance. For example, the vegetated canopy system may include an irrigation system and a drainage system to ensure plants receive sufficient water and nutrients and excess fluid in the soil drains freely. The vegetated canopy system may also be modular where one or more soil containers can be removed, replaced, rearranged, and so forth, by a user in a relatively easy manner.

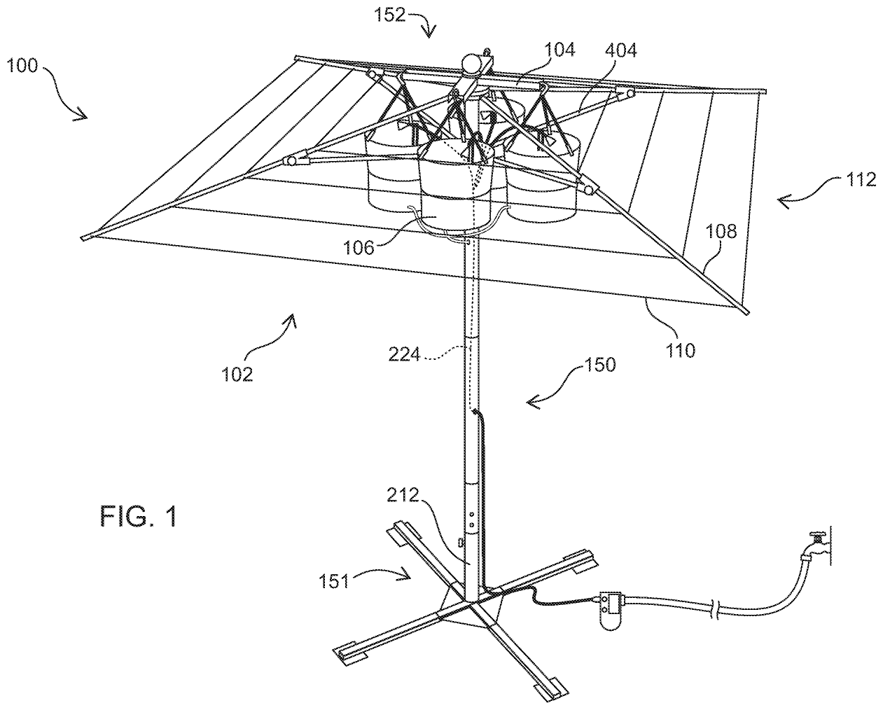

FIG. 1 illustrates an apparatus for supporting a vegetated canopy, in accordance with a representative embodiment. As shown in this embodiment, the apparatus 100 for providing a vegetated canopy may include an umbrella as a structure for supporting the vegetated canopy. In this embodiment, this implementation can be thought of as a ‘living umbrella’ or ‘living canopy’ because of the vegetated canopy that may be included thereon.

The apparatus 100 may include a vegetation support assembly 102 and a support structure 150. The support structure 150 may include a base 212 disposed on a bottom end 151 of the support structure 150. The vegetation support assembly 102 may be disposed on a top end 152 of the support structure 150. The overall height of the apparatus 100 from the bottom of base 212 to the top of vegetation support assembly 102 may include but is not limited to heights of about 96 inches to about 105 inches. The vegetation support assembly 102 may include a plurality of ribs 108, a plurality of supporting members 404, and a plurality of connecting members 110 forming a trellis 112 structurally configured to support vegetation. The vegetation support assembly 102 may include a plurality of soil containers 106 supported by a plurality of brackets 104.

The vegetation support assembly 102 and support structure 150 may include parts made from metal, including aluminum, stainless steel, powder-coated steel, and may include parts made from military- and marine-grade materials, including marine-grade aluminum, marine-grade powder-coated steel, and the like. For example, the support structure 150 and vegetation support assembly 102 may include metallic parts including one or more of the base 212, the plurality of ribs 108, the plurality of supporting members 404, and the plurality of connecting members 110. One or more of these parts may also or instead be made from other materials such as fiberglass, plastic, wood, bamboo, ceramic, and the like.

Each of the plurality of soil containers 106 may vary in size. The dimensions of soil container 106 may be typical of soil potting containers used in the nursery plant trade. For example, in implementations, the soil container 106 may include a capacity between about one and twenty-five gallons. The plurality of soil containers 106 may otherwise generally be sized and shaped to contain soil and plant roots, for example including soil containers 106 that are 10 inches in diameter. The plurality of plant containers 106 may be made of plastic, including polypropylene, recycled polypropylene, metal, including aluminum, clay, glazed ceramic, fiberglass, concrete, foam, and any other material suitable for housing soil, water, and vascular plants.

The plurality of ribs 108 may be structurally configured to support one or more vegetated canopies disposed thereon. Each of the plurality of supporting members 404 may be sized, shaped, and/or arranged to align with and fit onto or within each of the plurality of ribs 108 and the support structure 150 in one or more predetermined configurations. Both the plurality of ribs 108 and the plurality of supporting members 404 may be specifically tailored to be structural elements of an umbrella-like structure. For example, the plurality of ribs 108 may include members extending radially about a central axis. Each of the plurality of supporting members 404 comprises one or more fastening features configured to cooperate with corresponding fastening features disposed on the plurality of ribs. Each of the supporting members further comprises one or more engagement features structurally configured to cooperate with corresponding engagement features disposed on the support structure.

One skilled in the art will recognize that more or less ribs 108 are possible, and other implementations include at least five ribs 108, at least eight ribs 108, and other numbers of ribs. The number of ribs may determine the trellis 112 shape when viewed from above, for example an implementation including four ribs 108 will generate a square trellis 112 when viewed from above. Each rib 108 in the plurality of ribs 108 may be substantially equally spaced apart from the other ribs 108. The plurality of ribs 108 may be substantially cylindrical in shape, or they may include other shapes. The plurality of ribs 108 may include ribs having a diameter of about 0.5 inches, and/or a length of about 72 inches to 86 inches, and the ribs 108 may be adapted to support the limbs, leaves, and other parts of a vascular plant.

In an implementation, the support structure 150 may be adapted to contain one or more irrigation internal supply lines 224 inside a pathway extending from the bottom end 151 of the support structure 150 to the top end 152 of the support structure 150.

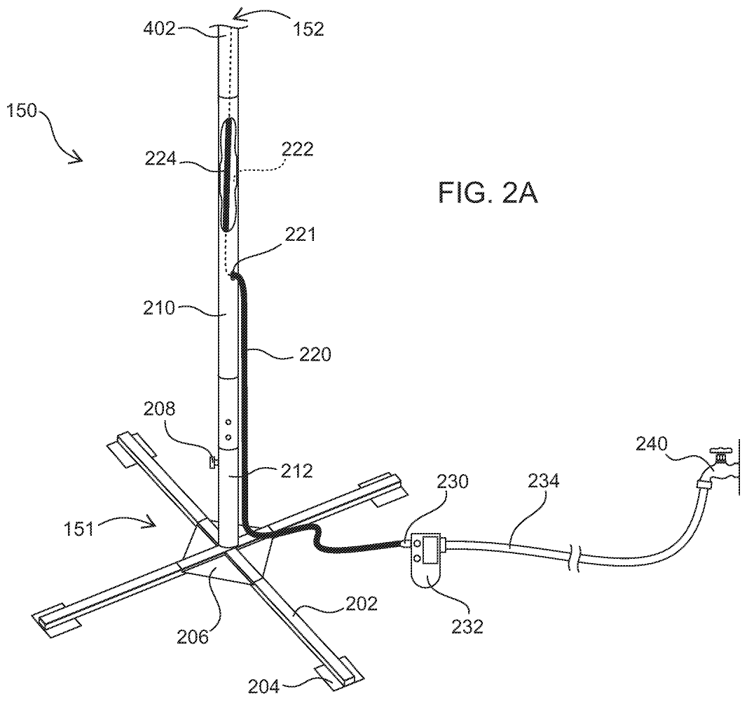

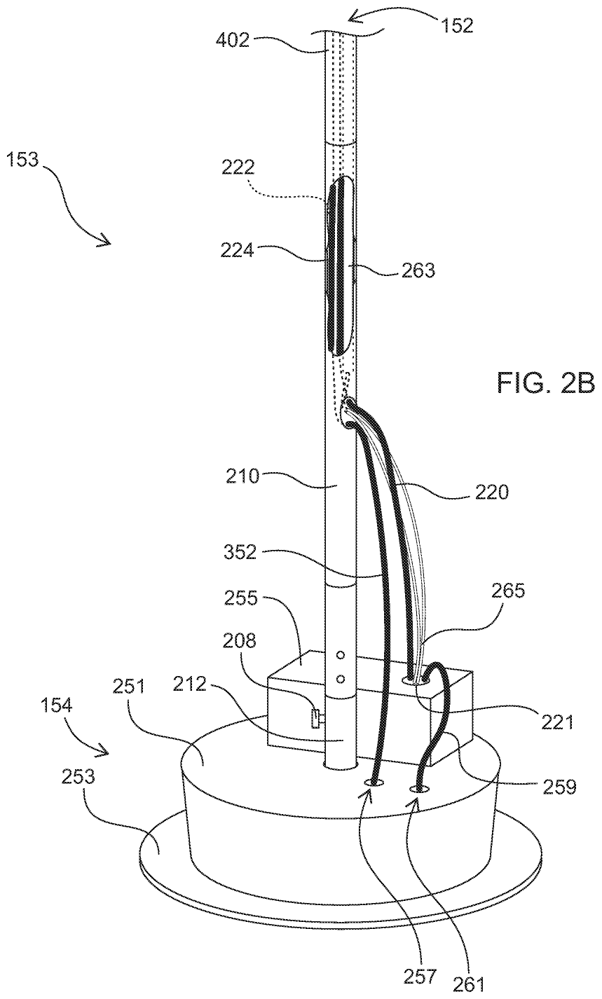

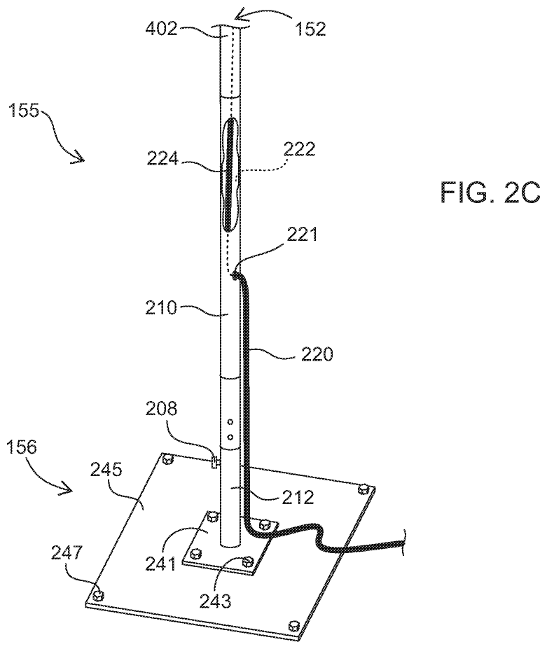

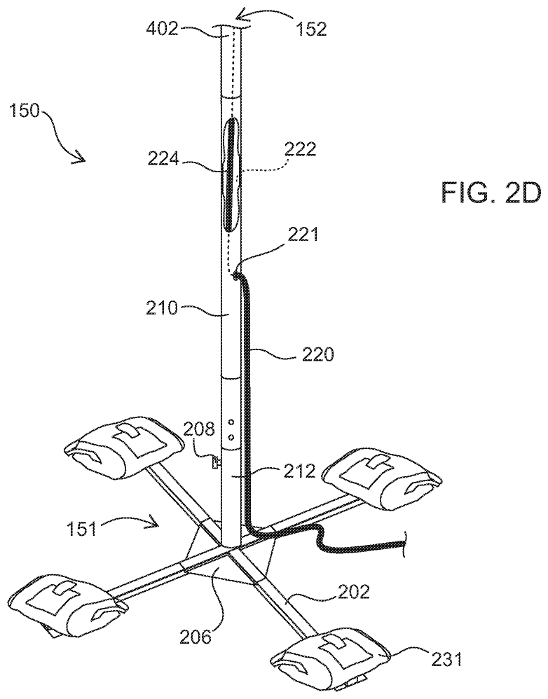

FIG. 2A illustrates a view of the support structure 150 of the apparatus for providing a vegetated canopy as depicted in FIG. 1 and in accordance with an embodiment of the present invention. FIG. 2A illustrates the support structure 150, which includes a bottom end 151 and a top end 152. The base 212 is disposed at the bottom end 151 of the support structure 150, and may include a base plate 206, a plurality of legs 202, and a plurality of leg plates 204. One or more posts may connect to the base 212 and extend from the bottom end 151 to the top end 152 of the support structure 150. The posts may include posts having a diameter of about 1.5 inches. In the depicted embodiment, the bottom post 210 connects to the base 212 and may be secured by set screw 208 and the top post 402 connects to the bottom post 210. These connections may be made by extensions protruding from one component and inserting into another component. For example, a male connector on top post 402 may extend into a female receiver on bottom post 210, or a male connector on bottom post 210 may extend into a female receiver on top post 402.

The post or posts may include a pathway 222 formed therein or thereon extending from the bottom end 151 of the support structure 150 to the top end 152 of the support structure 150 to support the vegetation with an irrigation system composed of one or more supply lines and wiring for electrical coupling, and a drainage system composed of one or more drain lines. Some or all of the pathway may be within a hollow core of one or more of the posts, including top post 402 and bottom post 210, as well as base 212, and some or all of the pathway may be externally located relative to the posts and base 212.

In order to facilitate maintenance of the vegetated canopy, an irrigation system may be integrated into embodiments of apparatus 100 to supply water from a water reservoir. This allows the apparatus 100 to be self-contained, e.g., where the apparatus 100 can maintain the health of vegetation included on the vegetated canopy without maintenance or interference from an outside source, or with relatively minimal maintenance or interference from an outside source.

As depicted in the embodiment illustrated in FIG. 2A, an external supply line 220 may connect to a controller 232, for example using a supply line adapter 230, and the controller 232 may connect to a hose 234, which may connect to a hose bibb 240 serving as a water reservoir. In the depicted embodiment, the external supply line 220 is in fluid communication with a hose 234 and hose bibb 240. In such an embodiment, the hose bibb 240 may supply adequate water pressure to provide water to the top end 152 of support structure 150. The external supply line 220 may run externally along base 212, enter bottom tube 210 through supply line entry hole 221, and continue internally within bottom post 210 and within top post 402. In this implementation, internal supply line 224 is disposed within the hollow core of bottom post 210 and top post 402. Thus, in this implementation water from hose bibb 240 travels through hose 234, controller 232, supply line adapter 230, external supply line 220, and internal supply line 224 to provide water to at least one of the soil containers 106 disposed at the top end 152 of the support structure 150.

The controller 232 may be electrically coupled to a power supply and may be programmed to control fluid flow from the hose bibb 240 to the external supply line 220. Controlling fluid flow may be based on a predetermined time interval or a predetermined schedule. Thus, implementations may include a controller 232 programmed to control an amount of water and/or nutrients supplied to at least one of the soil containers 106 disposed at the top end 152 of the support structure 150 based on more or more of a predetermined time interval or a predetermined schedule.

The controller 232 may be programmed manually or may include a communications interface for connection to a computing device through a network. The controller 232 may also or instead include, or otherwise be in communication with, a processor, memory, or any other hardware or software to perform its functions as described herein. In an implementation, the processor may be programmable, e.g., by a user's computing device, to set a predefined sequence of actuation for the controller 232.

FIG. 2B illustrates a view of a support structure 153 of an apparatus for providing a vegetated canopy in accordance with an embodiment of the present invention. FIG. 2B illustrates a support structure 153, which includes a bottom end 154 and a top end 152. The base 212 is disposed at the bottom end 154 of the support structure 153 and may include a reservoir-containing base 251 and a base stand 253. The reservoir-containing base 251 may include a water reservoir made of metal, plastic, including polyurethane, and the like (e.g., a 5-gallon plastic reservoir within a cylindrical base).

As depicted in the embodiment illustrated in FIG. 2B, a ‘smart’ irrigation system may be housed in a housing container 255 disposed at the bottom end 154 of the support structure 153 to maintain the health of vegetation included on the vegetated canopy without maintenance or interference from an outside source, or with relatively minimal maintenance or interference from an outside source. The ‘smart’ irrigation system may include one or more of a controller, a pump, a valve, and a power supply electrically coupled to one or more of the controller, pump, and valve. The pump and/or the valve may be connected to main line 259 with a first end disposed in the fluid reservoir 261 and a second end disposed in the housing container 221, where one or more of the pump and valve are structurally configured to control an amount of water and/or nutrients supplied through the supply line 220 to the top end 152 of the support structure 153. The valve may include a solenoid valve or the like that can open and close based on a signal provided, e.g., an electrical signal sent by the controller.

The irrigation system may include one or more moisture sensors configured to detect a moisture level in soil contained in one or more of the soil containers. The controller may be configured to receive a signal from the moisture sensor and to control operation of one or more of the pump and the valve in response to the signal. The controller may thus be configured to maintain moisture levels in soil contained in the plurality of soil containers within a predetermined range. One skilled in the art will recognize that more or fewer sensors are possible. For example, sensors can be included that sense thermal properties, atmospheric properties, contaminants, insects, fungus, pressure, humidity, and so forth. For example, the one or more sensors may also or instead include one or more of ultrasonic sensors, optical sensors, infrared sensors, temperature sensors, sound sensors, chemical sensors (e.g., oxygen, carbon dioxide, and so on), motion and proximity sensors, flow sensors, radiation sensors, imaging sensors, pressure sensors, shock sensors, force sensors, and the like. As discussed above, controlling operation of the pump and valve may be based on signals received from one or more sensors.

In implementations, electrical wiring 265 coupled to one or more of the valve, pump, controller, and components of a power supply may exit the housing container 255 disposed at the bottom end 154 of support structure 153 and extend toward the top end 152 of support structure 153 within wire harness 263 disposed inside pathway 222. In an implementation, the power supply includes a photovoltaic panel and a rechargeable battery. The photovoltaic panel may be disposed at the top end 152 of the support structure and electrically coupled to the rechargeable battery (e.g., through electrical wiring 265) disposed inside housing container 255. Thus, the power supply may include a solar energy system adapted to collect solar energy and convert the solar energy into electrical energy, where the solar energy system is conductively coupled to a rechargeable electrical power system for providing electrical power to one or more of the pump, the controller, and the sensors. The rechargeable battery may include a range of voltages and ampere hours, including but not limited to a 12V, 2.6 Ah battery or batteries in the range from 1 Ah to 250 Ah. The pump may include a range of pressures and flow rates, including but not limited to a 400 mL/min DC diaphragm pump or pumps in the range from 1 mL/min to 1000 mL/min. The photovoltaic panel may include a range of voltages and currents, including but not limited to an 18V solar panel.

In implementations, the apparatus may include a drainage system for draining excess fluid from irrigation or rainfall. As depicted in FIB. 2B, excess fluid collected from the plurality of soil containers disposed at the top end 152 of the support structure may drain through main drain line 352 to an end disposed inside the water reservoir 257 within the reservoir-containing base 251. Excess fluid may drain to the water reservoir where it is stored and reused when fluid is pumped from the fluid reservoir through main line 259 and supply line 220 to the plurality of soil containers disposed at the top end 152 of support structure 153.

FIG. 2C illustrates a view of a support structure 155 of an apparatus for providing a vegetated canopy in accordance with an embodiment of the present invention. FIG. 2C illustrates a support structure which includes a bottom end 156 and a top end 152. The bottom end 156 may be anchored to a fixed surface, including a deck, patio, or the ground, with bolts, nails, screws or any other suitable fastener. The base plate 241 may be anchored to a base stand 245 using a plurality of base plate bolts 243, and the base stand 245 may be anchored to a fixed surface using a plurality of base stand bolts 247.

FIG. 2D illustrates a view of the support structure 150 of the apparatus for providing a vegetated canopy as depicted in FIG. 1 and in accordance with an embodiment of the present invention. In this implementation, the bottom end 151 of support structure 150 may be stabilized by placing a plurality of sandbags 231 on components of the support structure 150, including on base plate 206, a plurality of legs 202, or a plurality of leg plates 204. In alternative embodiments, the support structure 150 may be stabilized by placing any suitable weight (e.g., steel plates bolted together) on any or all components of support structure 150.

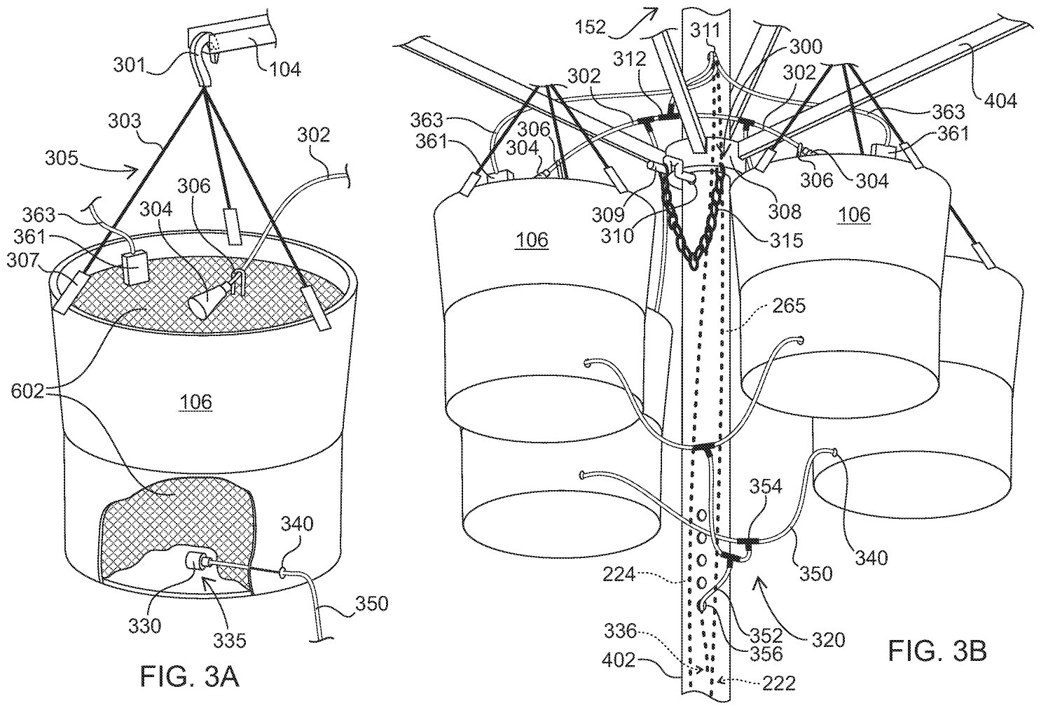

Referring now to FIGS. 3A and 3B, an embodiment of the present invention is depicted in greater detail. FIG. 3A illustrates one soil container and components of the irrigation and drainage systems, and FIG. 3B illustrates a plurality of soil containers disposed at the top end of the support structure.

In an implementation illustrated in FIG. 3A, a soil container 106 may be connected to a hanger 305 that may be hung from a bracket 104 disposed at the top end of the support structure. The hanger 305 may include attachments 307, straps 303, and a hook 301. The attachments 307 may be snap clips, manual screw lock carabiners, spring-loaded carabiners, straps, clevis fasteners, shackles, or any other fastener mechanism reasonably anticipated by one skilled in the art. The straps 303 may be flexible or non-flexible, and may include chains, wires, cords, cables, monofilaments, ropes, nylon or polyester slings, rods, or any other load bearing material reasonably anticipated by one skilled in the art. The hook 301 may include latched or unlatched hooks, including manual screw lock carabiners and spring-loaded carabiners, and may include eyes, clevis fasteners, or shackles for attachment to the straps 303, or any attachment mechanism reasonably anticipated by one skilled in the art.

The soil container 106 may thus be a raised container, e.g., disposed at or near the umbrella-like vegetation support assembly. The soil container 106 may integrally include a pot of soil or the like, may directly receive soil, or may include a structure for receiving a pot of soil or the like, e.g., containing roots or seeds of a plant. The soil container 106 may hold natural or engineered soil, the roots of a plant, water, or live vascular plants.

As illustrated in FIG. 3A, the soil container 106 may contain soil 602 which may contain roots or seeds of a plant. To ensure plants receive sufficient water and nutrients, the vegetated canopy system may include an irrigation system including at least one supply line and at least one irrigation line. The internal supply line 224 that brings water from a water reservoir may connect to a first end of an irrigation line 302. Irrigation line 302 may terminate with a drip emitter 304 at its second end disposed in a soil container 106. Irrigation line 302 and/or drip emitter 304 may be secured in a desired location by an irrigation clip 306 attached to the soil 602, plant, strap 303, or any other suitable location. In implementations of the present invention, drip emitters include button drip emitters, drip emitters with built-in check valve, inline drip emitters, adjustable drip emitters, flag drip emitters, mister sprayers, micro sprayers, sprayer jets, foggers, or any other irrigation fitting reasonably anticipated by one skilled in the art. The drip emitter 304 may also be secured in a desired location by an irrigation clip 306 including tubing stakes, loop stakes, inline stakes, or any other securing mechanism reasonably anticipated by one skilled in the art.

In implementations, the irrigation system may include one or more moisture sensors configured to detect a moisture level in soil contained in one or more of the soil containers. Moisture sensor 261 may be disposed on and/or in soil 602 disposed within soil container 106 and moisture sensor 261 may be coupled to wire 361 that is electrically coupled to electrical wiring coupled to one or more of the valve, pump, and controller. In this way, a signal from the moisture sensor may be received by the controller to control operation of one or more of the pump and the valve in response to the signal.

The cut away view of FIG. 3A depicts soil 602 and a drain 330 for draining excess fluid from irrigation or rainfall through drain line 350, e.g., a hose or tube, to promote the health of vegetation included on the vegetated canopy. The drain 330 may be disposed at a first end 335 of drain line 350 and may be disposed in soil container 106. The drain 330 may include a filter or mesh secured to the first end 335 by a zip tie or other suitable securing means to filter particulates and prevent clogging of the drainage system. The drain line 350 may exit the soil container through a drain hole 340 and drain excess fluid to a location outside of soil container 106.

FIG. 3B illustrates a view of a plurality of the individual soil containers depicted in FIG. 3A disposed at the top end of the support structure depicted in FIG. 1 and their use in a vegetated canopy system including irrigation and drainage systems in accordance with an embodiment of the present invention. Top post 402 may include internal supply line 224 disposed in pathway 222 extending from the bottom end of the support structure to the top end 152 of the support structure where it emerges through supply line exit hole 311. The supply line may connect to one or more irrigation fittings and/or couplings, e.g., irrigation tees 312, or an irrigation manifold to bring water to a plurality of soil containers 106 through a plurality of individual irrigation lines 302. Each irrigation line 302 terminates at an individual soil container 106 with a drip emitter 304 and is secured in location by an irrigation clip 306. Thus, water from a reservoir may travel in a supply line through a pathway from the bottom end of the support structure to the top end 152 of the support structure where it is distributed to a plurality of soil containers 106 by an irrigation system.

One or more moisture sensors 361 may be disposed on and/or in soil disposed within one or more soil containers 106 and may be coupled to wires 361 that are electrically coupled to electrical wiring 265 disposed within a wire harness inside pathway 222 and extending to the bottom of the support structure where the electrical wiring 265 may be coupled to one or more of the valve, the pump, the controller, and the power supply.

Excess fluid from irrigation or rainfall may drain through a drainage system 320. The drainage system 320 may include an individual drain line 350 that exits an individual soil container 106 through drain hole 340, one or more drain lines 350 that connect to one or more drain fittings and/or couplings, e.g., drain tees 354, and a main drain line 352 disposed external to the plurality of soil containers 106 to drain water away from a plurality of soil containers 106. The main drain line 352 may enter the top post 402 through a drain line entry hole 356 so that the main drain line 352 terminates at a second end 336 within the hollow core of top post 402, emptying its contents into top post 402 to flow freely through the support structure and out the base. In alternative embodiments, the main drain line 352 extends from the top end of the support structure to the bottom end of the support structure, and may be disposed inside or outside the posts and/or base, so that the main drain line 352 terminates on the ground proximal to the bottom end of the support structure, or is removed from the bottom end of the support structure to terminate distal to the bottom end of the support structure.

FIG. 3B illustrates a system for attaching the support structure to and supporting the vegetation support assembly. The slider assembly 300 includes a slider 308, fastener 309, fastener chain 315, and fastener entry hole 310 in top post 402. A plurality of supporting members 404 that support a plurality of ribs may be hingedly connected to slider 308 which may slide along top post 402. In this implementation, the slider assembly 300 may be an engagement feature disposed on the support structure that cooperates with corresponding engagement features of the supporting members 404. This permits the plurality of supporting members 404 and plurality of ribs to be lowered and raised by a user either manually or instead using the controller and power supply to power a mechanism, thereby lowering and raising the trellis. In an implementation, when the trellis is raised to a desired position, the user may secure the trellis in place by inserting the fastener 309 into fastener entry hole 310 so that the fastener 309 bears the weight of the trellis. The fastener 309 may be secured to the slider 308, a supporting member 404, or any other suitable component by a fastener chain 315, which may include chain, wire, rope, nylon or polyester slings or any other securing means reasonably anticipated by one skilled in the art.

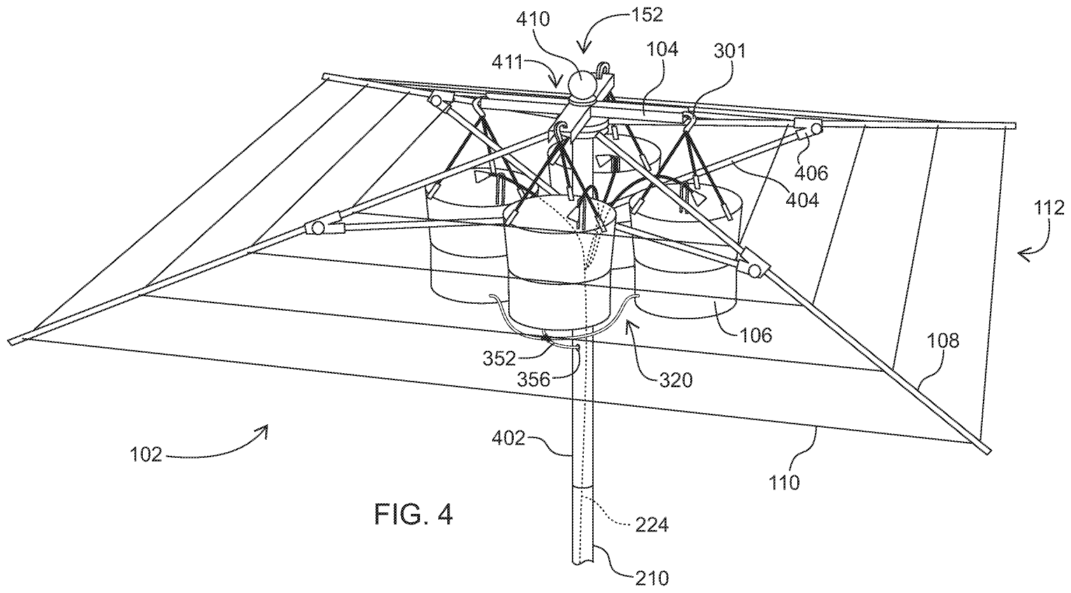

FIG. 4 illustrates a view of a vegetation support assembly 102 disposed at a top end 152 of a support structure configured to attach to and support the vegetation support assembly 102 in accordance with an embodiment of the present invention. The plurality of soil containers 106 may be supported, e.g., hanging by hooks 301, by a plurality of brackets 104 disposed at the vertex 411 (or other finial or sub-finial structure) at the top of the vegetation support assembly 102, which may include a finial 410 ornamenting the apex of the apparatus. When components are raised to a desired position and locked in place, trellis 112 is formed by the plurality of ribs 108, plurality of supporting members 404, and a plurality of connecting members 110. The connecting members 110 may be particularly suited to form the trellis 112 as they may be made from flexible or non-flexible materials, including wire of various gauges, including stainless steel cable, galvanized wire, monofilament wire, galvanized soft wire, or any other material of suitable tensile strength and properties to support growth of vegetation in both indoor and outdoor environments.

The plurality of ribs 108 may be supported by a plurality of supporting members 404. The plurality of supporting members 404 may be sized sand shaped to align with and fit onto or within at least one of the plurality of ribs 108 and the support structure. Each of the supporting members 404 may be hingedly attached to each of the ribs 108 at a support attachment 406. In this implementation, the support attachments 406 may be fastening features disposed on the supporting members 404 that cooperate with corresponding fastening features of the plurality of ribs 108. Each of the ribs 108 may be hingedly attached at a central vertex 411 or other sub-finial structure disposed at the top end 152 of the support structure. The plurality of supporting members 404 may be moveably connected to the support structure, for example the supporting members 404 may be hingedly connected to a slider which may slide along top post 402. This permits the plurality of supporting members 404, plurality of ribs 108, and plurality of connecting members 110 to be lowered and raised by a user, thereby reconfiguring trellis 112.

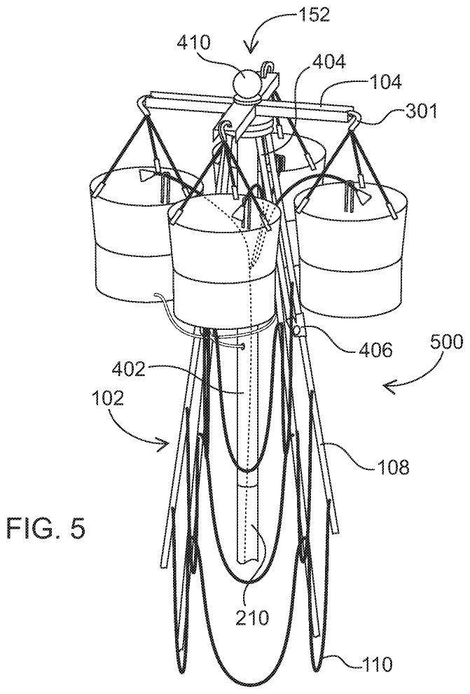

FIG. 4 illustrates one configuration of the vegetation support assembly 102 in accordance with an embodiment of the present invention. This configuration is a ‘raised’ or ‘open’ configuration where a trellis 112 is formed to support vegetation. FIG. 5 illustrates reconfiguration of trellis 112 to a ‘lowered’ or ‘collapsed’ configuration where a collapsed trellis 500 is formed. A user may easily reconfigure the vegetation support assembly 102 from an open a trellis 112 to a collapsed trellis 500 and vice versa by sliding the slider assembly described with reference to FIG. 3B along the support structure. The slider of the slider assembly may be locked into position in the raised configuration to form a trellis structurally configured to support vegetation.

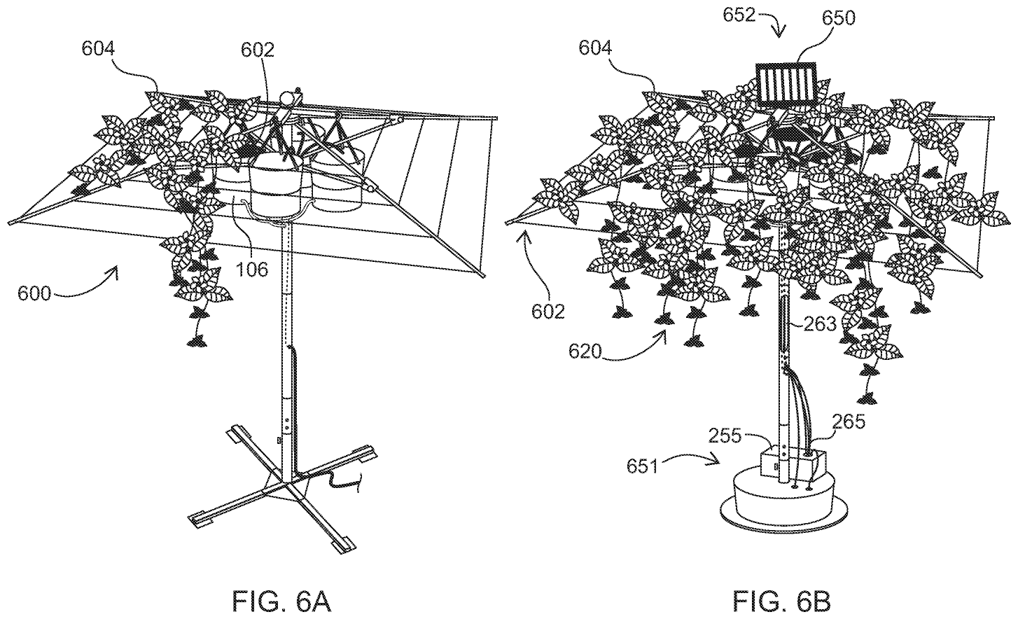

FIG. 6A and FIG. 6B illustrate embodiments of an apparatus and system including vegetated canopies in accordance with the present invention. As depicted in FIG. 6A, in an alternative embodiment of the vegetated canopy system, one soil container 106 may contain soil 602 and the apparatus may support one plant 604, resulting in a partially vegetated canopy 600. In alternative embodiments of the vegetated canopy system, a plurality of soil containers may contain soil and the apparatus may support a plurality of plants, resulting in a partially or fully vegetated canopy. As depicted in FIG. 6B, in an alternative embodiment of the vegetated canopy system, all soil containers may contain soil and the apparatus may support several plants 604, resulting in a fully vegetated canopy 620.

In the embodiment illustrated in FIG. 6B, a photovoltaic panel 650 may be disposed on vegetation support assembly 602 and may be operable to supply power to a rechargeable battery within housing container 255 through electrical wiring 265 disposed within wire harness 263 extending from the top end 652 of the support structure to the bottom end 651 of the support structure.

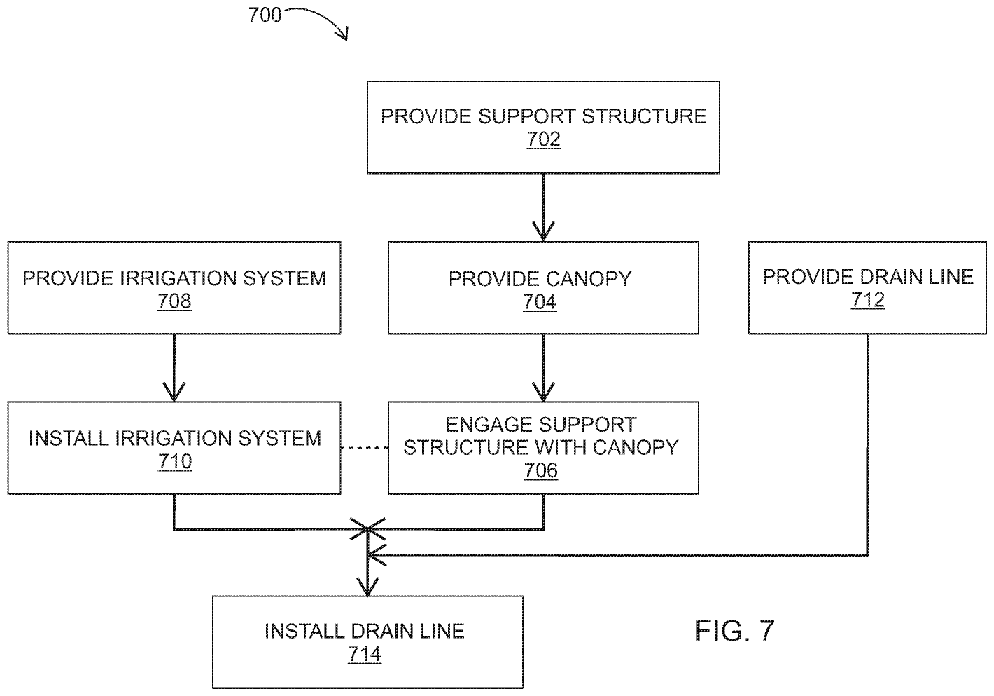

FIG. 7 illustrates a flow chart of a method for providing a vegetated canopy in accordance with a representative embodiment. In general, the method 700 may include forming a vegetated canopy system through engagement of a support structure with a vegetation support assembly. As shown in block 702, the method 700 may include providing a support structure. As shown in block 704, the method 700 may include providing a vegetation support assembly. The vegetation support assembly may include a plurality of soil containers supported by a plurality of brackets, a plurality of ribs supported by a plurality of supporting members, and a plurality of connecting members attaching at least one of the plurality of ribs to another one of the plurality of ribs, the plurality of connecting members and the plurality of ribs thereby forming a trellis structurally configured to support vegetation.

As shown in block 706, the method 700 may include engaging the support structure with the vegetation support assembly to form a vegetated canopy system by configuring the support structure to attach to and support the vegetation support assembly.

In alternative embodiments of the present invention, the method 700 may include providing an irrigation system as shown in block 708. The irrigation system may include at least one supply line extending from a bottom end of the support structure to a top end of the support structure to provide one or more of water and nutrients from the bottom end of the support structure to the plurality of soil containers, where the plurality of soil containers is disposed at the top end of the support structure. The irrigation system may include at least one drip emitter disposed in at least one of the soil containers and connected to the supply line by an irrigation line. The irrigation system may include a controller operable to control on a predetermined time interval an amount of one or more of water and nutrients from a water reservoir in fluid communication with the supply line to at least one of the soil containers. The irrigation system may include a pump, a valve, one or more moisture sensors, a photovoltaic panel, a rechargeable battery, and electrical wiring operable with the controller. As shown in block 710, the method 700 may include installing the irrigation system while engaging the support structure with the vegetation support assembly to form a vegetated canopy system.

In alternative embodiments of the present invention, the method 700 may include providing at least one drain line as shown in block 712. The drain line or drain lines may be operable to drain fluid from within a soil container or soil containers to a location external to the soil container or soil containers. As shown in block 714, the method 700 may include installing one or more drain lines in the vegetated canopy system.

One of the advantages of the vegetated canopy system is that it may allow for a plant to be grown at a nursery prior to installation within the vegetated canopy apparatus. This may ensure that the apparatus can be equipped with a fully-grown plant canopy when it is placed into service at an establishment, e.g., at a residence or a commercial establishment such as a restaurant. This vegetated canopy system may thus allow for relatively easy removal and replacement of plants and vegetation on the trellis.

Thus, in an implementation of the vegetated canopy system, ore or more plants 604 may form one or more partially or fully vegetated canopies disposed on the trellis. The vegetated canopies may include one or more vascular plants selected such that the vegetated canopies can perform one or more of: absorbing direct and indirect ultraviolet radiation; reducing noise by absorbing sounds in wave frequencies audible to a human ear; providing shade by absorbing and reflecting direct and indirect solar radiation; absorbing heat from its immediate surroundings via plant leaf transpiration; and removing volatile organic compounds from its immediate surroundings via plant leaf gas exchange. For example, the vegetated canopies may absorb a majority of the direct and indirect ultraviolet radiation (e.g., A+B, 290-400 nm) from the sun and surrounding surfaces. Also, soil included as part of the plurality of soil containers or the vegetated canopies may include a natural or engineered soil that removes volatile organic compounds from their immediate vicinity via the process of soil microbial metabolism.

As described above, one or more plants 604 may form one or more partially or fully vegetated canopies disposed on the trellis for the vegetated canopy system. For example, the vegetated canopy may include vegetation selected from one or more of the following plant species (which are provided by way of example and not of limitation): Actinida arguta, Antigonon leptopus, Bauhinia corymbosa, Bignonia capreolata, Bougainvillea spectabilis, Callisia repens, Campsis radicans, Celastrus scandens, Clematis, Clematis paniculate, Ficus pumil, Gelsemium sempevirens, Hedera helix, Humulus lupulus, Hydrangea anomala petiolaris, Ipomoea batatas, Ipomoea coccinea, Lonicera periclymenum, Lonicera sempevirens, Mandevilla amabilis, Mandevilla hybrids, Mandevilla sanderi, Mandevilla splendens, Mandevilla spp., Pandorea jasminoides, Parthenociscus quinquefolia, Passiflora incarnata, Philodendron scandens, Piper nigrum, Podranea ricasoliana, Pseudocalymma alliaceum, Pyrostegia venusta, Quigualis indica, Schizophragma integrilfolium var. faurei, Trachelospermum jasminoides, Vigna caracalla, Vitis acerifolia, Vitis blancoi, Vitis bloodworthiana, Vitis bourquiniana, Vitis californica, Vitis champini, Vitis champinii, Vitis cinerea, Vitis coignetiae, Vitis davidii, Vitis doaniana, Vitis ficifolia, Vitis flexuosa, Vitis girdiana, Vitis jacquemontii, Vitis labrusca, Vitis monticola, Vitis mustangensis, Vitis nesbittiana, Vitis novae-angliae, Vitis palmate, Vitis piasezkii, Vitis popenoei, Vitis riparia, Vitis romanetii, Vitis rotundifolia, Vitis rupestris, Vitis aestivalis, Vitis amurensis, Vitis andersonii, Vitis arizonica, Vitis berlandieri×rupestris, Vitis betulifolia, Vitis biformis, Vitis shuttleworthii, Vitis slavinii, Vitis spp., Vitis tiliifolia, Vitis treleasei, Vitis vinifera, Vitis vulpine, Vitis wilsonae, Wisteria frutescens, and the like.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A system, comprising:
a vegetation support assembly comprising:
a plurality of soil containers supported by a plurality of brackets;
a plurality of ribs supported by a plurality of supporting members; and
a plurality of connecting members attaching at least one of the plurality of ribs to another one of the plurality of ribs, the plurality of connecting members and the plurality of ribs thereby forming a trellis structurally configured to support vegetation; and
a support structure configured to attach to and support the vegetation support assembly.

2. The system of claim 1, further comprising at least one supply line extending from a bottom end of the support structure to a top end of the support structure to provide one or more of water and nutrients from the bottom end of the support structure to the plurality of soil containers, where the plurality of soil containers is disposed at the top end of the support structure.

3. The system of claim 2, further comprising an irrigation system comprising:
at least one irrigation line operable to bring one or more of water and nutrients from a first end of the irrigation line connected to the supply line to a second end of the irrigation line disposed in at least one soil container; and
a controller operable to control on a predetermined time interval an amount of one or more of water and nutrients to at least one of the soil containers from a water reservoir in fluid communication with the supply line and at least one irrigation line.

4. The system of claim 3, further comprising:
one or more of a pump and a valve connected to the supply line and structurally configured to control an amount of one or more of water and nutrients supplied through the supply line to at least one of the soil containers; and
a power supply electrically coupled to one or more of the pump, the valve, and the controller.

5. The system of claim 4, further comprising at least one moisture sensor configured to detect a moisture level in soil contained in at least one soil container, where the controller is configured to receive a signal from the moisture sensor and to control operation of one or more of the pump and the valve in response to the signal.

6. The system of claim 4, where the power supply comprises a photovoltaic panel and a rechargeable battery.

7. The system of claim 3, further comprising at least one drain line operable to drain fluid from a first end of the drain line disposed in a soil container to a second end of the drain line disposed external to said soil container.

8. The system of claim 1, wherein each of the plurality of supporting members is sized and shaped to align with and fit onto or within at least one of the plurality of ribs and the support structure, each of the plurality of supporting members comprises one or more fastening features structurally configured to cooperate with corresponding fastening features disposed on the plurality of ribs, and each of the plurality of supporting members comprises one or more engagement features structurally configured to cooperate with corresponding engagement features disposed on the support structure to align the plurality of supporting members and plurality of ribs in a predetermined configuration.

9. The system of claim 8 wherein the one or more engagement features comprises a slider assembly comprising:
a slider that hingedly engages the plurality of supporting members and slides along the support structure; and
a fastener that secures the slider to the support structure.

10. A system, comprising:
a vegetation support assembly comprising:
a plurality of soil containers supported by a plurality of brackets;
a plurality of ribs supported by a plurality of supporting members; and
a plurality of connecting members attaching at least one of the plurality of ribs to another one of the plurality of ribs, the plurality of connecting members and the plurality of ribs thereby forming a trellis structurally configured to support vegetation; and
a support structure configured to attach to and support the vegetation support assembly comprising:
a base disposed on a bottom end of the support structure; and
one or more posts connected to the base, the posts extending from the bottom end of the support structure to a top end of the support structure.

11. The system of claim 10, wherein the support structure is configured to receive at least one supply line disposed in a pathway within part or all of one or more of the posts, said pathway extending from the bottom end of the support structure to the top end of the support structure to provide one or more of water and nutrients to one or more of the soil containers.

12. The system of claim 11, further comprising an irrigation and drainage system comprising:
at least one irrigation line operable to bring one or more of water and nutrients from a first end of the irrigation line connected to the supply line to a second end of the irrigation line disposed in at least one soil container;
a controller operable to control on a predetermined time interval an amount of one or more of water and nutrients to at least one of the soil containers from a water reservoir in fluid communication with the supply line and at least one irrigation line; and
at least one drain line operable to drain fluid from a first end of the drain line disposed in a soil container to a second end of the drain line disposed in a post connected to the base, in a water reservoir at the bottom end of the support structure, or on the ground proximal to or distal to the bottom end of the support structure.

13. The system of claim 12, further comprising:
one or more of a pump and a valve connected to the supply line and structurally configured to control an amount of one or more of water and nutrients supplied through the supply line to at least one of the soil containers;
at least one moisture sensor configured to detect a moisture level in soil contained in at least one soil container, where the controller is configured to receive a signal from the moisture sensor and to control operation of one or more of the pump and the valve in response to the signal; and
a power supply electrically coupled to one or more of the pump, the valve, and the controller.

14. The system of claim 13, where the power supply comprises a photovoltaic panel and a rechargeable battery.

15. The system of claim 14, wherein each of the plurality of supporting members comprises one or more fastening features structurally configured to cooperate with corresponding fastening features disposed on the plurality of ribs, and each of the plurality of supporting members comprises one or more engagement features structurally configured to cooperate with corresponding engagement features disposed on the support structure to align the plurality of supporting members and plurality of ribs in predetermined configurations on the support structure.

16. The system of claim 15, wherein the one or more engagement features comprises a slider assembly comprising:
a slider that hingedly engages the plurality of supporting members and slides along the support structure; and
a fastener that secures the slider to the support structure.

17. A method comprising:
providing a support structure;
providing a vegetation support assembly comprising:
a plurality of soil containers supported by a plurality of brackets;
a plurality of ribs supported by a plurality of supporting members; and
a plurality of connecting members attaching at least one of the plurality of ribs to another one of the plurality of ribs, the plurality of connecting members and the plurality of ribs thereby forming a trellis structurally configured to support vegetation; and
engaging the support structure with the vegetation support assembly to form a vegetated canopy system by configuring the support structure to attach to and support the vegetation support assembly.

18. The method of claim 17 further comprising:
providing an irrigation system comprising:
at least one supply line extending from a bottom end of the support structure to a top end of the support structure to provide one or more of water and nutrients from the bottom end of the support structure to the plurality of soil containers, where the plurality of soil containers is disposed at the top end of the support structure; and
at least one irrigation line operable to bring one or more of water and nutrients from a first end of the irrigation line connected to the supply line to a second end of the irrigation line disposed in at least one soil container; and
installing the irrigation system while engaging the support structure with the vegetation support assembly to form a vegetated canopy system.

19. The method of claim 18 wherein the irrigation system further comprises one or more of a controller, a sensor, a pump, a valve, and a power supply electrically coupled to one or more of the controller, the sensor, the pump, and the valve and operable to control on a predetermined time interval or desired soil moisture content an amount of one or more of water and nutrients to at least one of the soil containers from a water reservoir in fluid communication with the supply line and at least one irrigation line, and the irrigation system installation step further comprises installing the controller, the sensor, the pump, the valve, and the power supply.

20. The method of claim 18 further comprising:
providing at least one drain line operable to drain fluid from a first end of the drain line disposed in a soil container to a second end of the drain line disposed external to said soil container; and
installing one or more drain lines in the vegetated canopy system.
